(19) United States
(12) Patent Application Publication
(10) Pub. No.: US 2005/0125493 A1
(43) Pub. Date: Jun. 9, 2005

(54) IP-based mechanism for location service systems, methods, and devices

(76) Inventors: Hemant Chaskar, (US); Margaret M. Livingston, (US); Sreenivas Addagatla, (US)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/987,221

(22) Filed: Nov. 12, 2004

Related U.S. Application Data
(60) Provisional application No. 60/519,558, filed on Nov. 13, 2003.

(51) Int. Cl. G06F 15/16

(52) U.S. Cl. 709/203

(57) ABSTRACT

Provided are improved systems, methods, and devices for IP-based location service (LCS). Using one or more IP-based protocols for LCS signaling efficiently re-uses existing, implemented, and reliable protocols and increases the robustness of the LCS signaling. Particular implementations of LCS messaging call flows make efficient use of wireless bandwidths and support IP-based LCS by organizing communications and signaling to limit required communications so that IP-based protocols may be used, rather than relying upon SS7 signaling and LCS-specific communication protocols.

### CROSS-REFERENCE TO RELATED APPLICATION

This application claims priority to and the benefit of the filing date of provisional application entitled “Providing Location Services in cdma2000 Network Over Internet Protocol (IP),” assigned Ser. No. 60/519,558 and filed Nov. 13, 2003, which is hereby incorporated by reference. The contents of co-pending application entitled “IP-Based Location Service within Code Division Multiple Access Network,” assigned Ser. No. 10/611,053 and filed on Jun. 30, 2003, are incorporated by reference in entirety. The contents of co-pending application entitled “Apparatus, and Associated Method, for Facilitating Location Determination of a Mobile Station Pursuant to a Location Based Application” assigned Ser. No. 10/923,497 and filed on Aug. 20, 2004, are incorporated by reference in entirety.

### FIELD OF THE INVENTION

The present invention relates generally to systems, methods, and devices for providing location information regarding a mobile station in a radio communication system and, more particularly, to IP-based mechanisms for location service systems, methods, and devices for providing location information to and for a mobile station.

### BACKGROUND

In many wireless communication networks and other mobile networks, the network keeps track of the location of mobile stations, such as mobile telephones, at least on a cell level. In such networks, it is typically also possible to determine the physical, geographical location of the mobile stations, and deliver the geographical location to a requesting entity, according to various well known techniques. For example, the Mobile Location Protocol (MLP), developed by the Location Interoperability Forum (LIF), provides one such technique for the delivery of location information for location services (LoCation Services or LCSs). For more information on the MLP, see the LIF technical specification TS 101 entitled Mobile Location Protocol, the contents of which are hereby incorporated by reference in its entirety. The Wireless Application Protocol (WAP or W@P™) Forum has also defined a location service (LCS) architecture and protocol. For more information on WAP LCS, see, for example, the Sep. 12, 2001, versions of the WAP location architecture specification WAP-256-LOCFW-20010912-a entitled Location Framework Overview, the WAP location protocol specification WAP-257-LOCPROT-20010912-a entitled Location Protocols, and the WAP XML document format specification WAP-258-LOCFORM-20010912-a entitled Location XML Document Formats, each of the contents of which are hereby incorporated by reference in their entireties. Location service (LCS) enables and supports geographical positioning of a mobile station whenever a user wants to use a location-based application or service.

Information regarding the location of the mobile stations can be utilized for a number of different purposes, such as for routing and charging, as well as for support of location services (LCSs), such as providing directions to nearby restaurants, gas stations, hotels, and the like and locating physical assets such as to assist in operations of a company using mobile equipment, vehicles, and/or personnel. Various services can be provided to or for a mobile station based at least partly on the physical location of the mobile station. For example, local weather forecasts, traffic announcements, news, and other local services may be provided for a user of a mobile station. These services may function based on location determination of the mobile station, rather than the user entering his or her location. For example, a user visiting a city and unfamiliar with his or her location may request a taxi by selecting a location service for ordering a taxi, such as sending a request over the Internet for the taxi ordering location service. The location service can identify the location of the mobile station and order a taxi to that location. For services, such as weather forecasts, a mobile subscriber may generally wish the service be supported by a location service (LCS) so the weather forecast is automatically related to his or her current location, specifically the location of his or her mobile station.

A Global Positioning System (GPS) may be used for determining the location of a mobile station. To help overcome limitations of GPS location, such as the reception of GPS receivers in a mobile station, Assisted GPS (A-GPS) may be used where the communications network provides some assistance data to the mobile station. A communication network can further assist in location determination of a mobile station by using a Position Determining Entity (PDE) to perform the complex measurements and calculations to determine the location of the mobile station. For example, a mobile station and a PDE may exchange location information for GPS or A-GPS positioning using IS-801 messages. For more information on IS-801 messages for positioning using a PDE, see the TIA/EIA November 1999 document on IS-801 entitled Position Determination Service Standard for Dual-Mode Spread Spectrum Systems. Various other methods may be used to obtain position information for a mobile station by communication between the wireless communication network and the mobile station according to one or more appropriate techniques, such as triangulation, Time of Arrival (TOA), Observed Time Difference of Arrival (OTDOA), or the like as are well known to those skilled in the art.

Location service (LCS) architectures and protocols have been developed to operate using the Signal System 7 (“SS7”) network and signaling. However, SS7 provides limited architectures and has inherent weaknesses due to its monolithic structure. Further, the entities operating to perform LCS have to interact using SS7 signaling. Various other systems and protocols, such as gpsOne® of Qualcomm®, Inc., have also been promulgated. For more information about gpsOne, see, for example, the gpsOne Overview document and the gpsOne® Position Location Technology document by Qualcomm®, Inc. However, many of these other systems and protocols are predicated upon traditional circuit-switched architectures using SS7 signaling and/or relying upon awkward or cumbersome methods for protocol communications, such as using Remote Authentication Dial-and User Service (RADIUS) protocols.

Accordingly, there is a need in the art for an improved system, method, and device for providing location services (LCSs) for mobile stations operating in radio communication systems.

In light of the foregoing background, embodiments of the present invention provide improved systems, methods, and devices for providing an IP-based scheme to facilitate location services (LCSs). More specifically, embodiments of the present invention provide for IP-based location service (LCS) in CDMA network architectures, such as in a cdma2000 network architecture. One advantage of embodiments of the present invention is that interactions for location service (LCS) between mobile stations and network nodes, such as PDEs and Positioning Centers, and interactions for location service (LCS) between network nodes may be effected over IP, i.e., embodiments of the present invention enable IP-based location service (LCS). As IP-based access becomes more readily available and standardized in CDMA and other radio access networks, IP-based location service (LCS) is desirable. For example, by using IP-based LCS, such as using HTTP for LCS, an existing protocol, i.e., HTTP, can be re-used for LCS, such as where HTTP headers are used for LCS. Another advantage of embodiments of the present invention is that for situations where a mobile station is roaming in a visited network, the interactions for LCS are coordinated primarily by the SPC for the mobile station in the visited network, rather than coordinated primarily by HPC for the mobile station in the home network. Moving the primary network entity for the LCS operation from the home network to the visited network reduces the overall network traffic to perform the LCS operation by allowing the local network which performs the geographical positioning to also be the primary point of communication for the LCS operation.

Embodiments of methods for LCS of the present invention may include activating an LCS Client, requesting position information from a positioning center such as an SPC or HPC, receiving the identity of a PDE from the positioning center, and messaging the PDE. These functions provide for terminal-initiated LCS, which may also include a preliminary step of initiating the LCS such as by accessing a location-based application. Similarly, activating the LCS Client may occur by requesting location information for a location-based application. The request for the position information may be in the form of an IP protocol such as HTTP. Further embodiments of methods of LCS of the present invention may also include the step of identifying the positioning center, typically performed by a terminal with a DNS query, but possibly performed by another network entity such as a gateway. Methods of LCS may also include the steps of calculating and then transmitting position information and/or the steps of authorizing the requested position information at the positioning center, selecting the PDE, transmitting the identity of the selected PDE, and possibly also receiving position information at the positioning center.

Further embodiments of methods for LCS of the present invention include the steps of activating an LCS Client, requesting position information from an SPC, receiving the identity of a PDE from the SPC, and messaging the PDE. The position information request to the SPC may include providing authentication information for the HPC. GPS information may be provided to the PDE so the PDE can calculate position information, rather then requiring the terminal to perform the GPS measurement calculations. The PDE may transfer the position information itself, or the position information may be received from the PDE and transmitted for delivery to a location-based application.

Further embodiments of methods for LCS of the present invention include the steps of receiving a position request from a terminal for position information for the terminal, authenticating and authorizing the position request for the terminal, and identifying a PDE to interact with the terminal to determine the position information. The PDE may also be selected prior to identifying the PDE to interact with the terminal. The position request may include the identification of the terminal and the base station communicating with the terminal, and the selection of the PDE may include using at least some of this identifying information. Authenticating the position request may include transmitting authentication information to a home network entity for the terminal such as a HPC. Further, receiving a position request may include receiving information identifying the terminal and the HPC for the terminal.

Embodiments of systems capable of supporting LCS of the present invention include a client node, one or more server nodes, a location-based application, and an LCS Client. The client node and server nodes are communicably coupled, as is the location-based application coupled to at least one of the client node and a first server node. The LCS Client is communicably coupled to at least one of the location-based application, the client node, and one of the server nodes. The location-based application is capable of issuing a position information request; the LCS Client is capable of being activated in response to the position information request; and the client node is capable of issuing a positioning request to one of the server nodes. An embodiment of system for supporting LCS may also include a PDE communicably coupled to the server node receiving the positioning request and the client node, and the server node receiving the positioning request is capable of selecting the PDE. The server node receiving the positioning request may also be capable of authorizing and authenticating the positioning request. The server node receiving the positioning request may be a second server node. The LCS Client may be co-located at one of a third server node and the client node. The location-based application and the LCS Client may be co-located at the client node. The location-based application may be communicably coupled to and co-located at the first server node. And the LCS Client may be co-located at one of the first server node and the client node.

Embodiments of client devices of the present invention are provided that include a controller and an LCS Client. The controller is capable of interacting with a location-based application, and the LCS Client is communicably coupled to the controller and capable of activation upon receipt of a position information request from the location-based application. The LCS Client is also capable of transmitting a positioning request to an SPC and receiving a response indicating the identity of a PDE to interact with the LCS Client. The LCS Client may be capable of operating in accordance with one or more IP-based communication protocols for transmitting the positioning request and receiving the response. A client device may also comprise the location-based application communicably connected to the controller.

Embodiments of servers of the present invention are provided that include a controller and memory coupled to the controller. The controller is capable of supporting location service for a mobile station by receiving a positioning request from the mobile station, authorizing and authenticating the positioning request, and transmitting the identity of a PDE to the mobile station. The memory is capable of storing information identifying at least one of a location-based application requiring position information and an LCS Client requesting the position information, and the controller is further capable of receiving position information from one of the mobile station and the PDE and forwarding the position information to at least one of the location-based application and the LCS Client.

These characteristics, as well as additional details, of the present invention are further described herein with reference to these and other embodiments.

### BRIEF DESCRIPTION OF THE DRAWING(S)

Having thus described the invention in general terms, reference will now be made to the accompanying drawings, which are not necessarily drawn to scale, and wherein:

FIG. 1 is a functional block diagram of a communication system capable of operating and/or supporting embodiments of the present invention;

FIG. 2 is a control flow diagram illustrating IP-based location service of an embodiment of the present invention;

FIG. 3 is a control flow diagram illustrating IP-based location service of another embodiment of the present invention;

FIG. 4 is a schematic block diagram of an entity capable of operating as a mobile station, Position Determining Entity, Serving Positioning Center, Home Positioning Center, or other network node according to an embodiment of the present invention; and

FIG. 5 is a schematic block diagram of a mobile station capable of operating in accordance with an embodiment of the present invention.

### DETAILED DESCRIPTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

While a primary use of the present invention may be in the field of mobile location services and applications, it will be appreciated from the following description that the invention is also useful for various other types of wireless and wired location services and applications. Further, while a primary use of mobile stations of the present invention may be in the field of mobile phone technology, it will be appreciated from the following that many types of devices that are generally referenced herein as mobile stations, including, for example, mobile phones, pagers, handheld data terminals and personal data assistants (PDAs), portable personal computer (PC) devices, electronic gaming systems, global positioning system (GPS) receivers, satellites, and other portable electronics, including devices that are combinations of the aforementioned devices may be used with the present invention.

The present invention is described herein with particular reference to IP-based location services (LCSs) in a cdma2000 network; however, it will be appreciated from the following description that the invention may be used in other CDMA and radio networks, i.e., the present invention is independent of the particular access network providing the communication channel for the location service (LCS). The terms “client device” and “client node” as used herein refer to any machine or like device which has communication functionality to operate according to an embodiment of the present invention and includes, but is not limited to, mobile stations such as mobile phones and like portable, wireless devices.

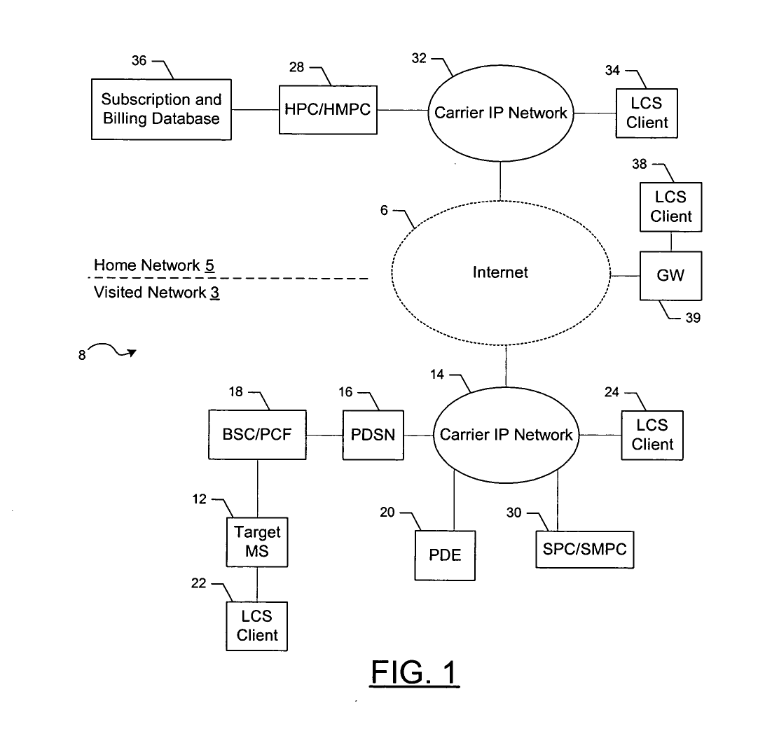

FIG. 1 is a functional block diagram of a communication system capable of operating and/or supporting embodiments of the present invention. The communication system 8 includes a home network 5 and a visited network 3 connected together by way of a packet data network, here the Internet 6. The packet radio communication system 8 provides packet radio communication services with mobile stations, such as a target mobile station (target MS) 12. The target MS 12 is permitted mobility to be positioned at any of various locations, including locations encompassed by the home network 5 and visited network 3 of the communication system 8. In the positioning shown in FIG. 1, the target MS 12 is positioned at the visited network 3 and is in communication connectivity therewith. That is to say, the target MS 12 is positioned at a location permitting its communication with the visited network 3 of the communication system.

A location service client (LCS client) 22 is installed and operable at the target MS 12. The LCS Client 22 forms an application, or other entity, that initiates location services and receives geographical location information associated with the target MS 12. Additional location service clients 24, 34, and 38 are also shown in FIG. 1. These additional location service clients 24, 34, and 38 are representative of location service clients 24, 34, and 38 positioned throughout various parts of the communication system 8. The additional location service clients 24, 34, and 38 are each representative of entities capable of initiating a location service and of receiving geographical location information of a mobile station, such as the target MS 12. LCS Clients may be connected through a gateway 39 that directs position requests to the appropriate home location network entity for the mobile station for which the position information is being requested for the location service.

Location services (LCSs) may be initiated at a mobile station, such as where a Location Service (LCS) Client 22 resides in the target MS 12. For example, an LCS Client resident in a mobile station may be activated from a terminal user interface (UI), such as running a J2ME application that requires geographical location information about the mobile station. Alternatively, for example, an LCS Client resident in a mobile station may be activated by events generated by entities other than the mobile station, such as a consumer application on a web server issuing a location query to the mobile station. Location services (LCSs) may also be initiated on a network, such as where an LCS Client 24, 34, 38 resides on the network. For example, an LCS Client resident on a network may be activated from a mobile station, such as when a user is browsing a network from the mobile station. Alternatively, for example, an LCS client resident on a network may be activated by events generated by entities other than the mobile station, such as a fleet manager application obtaining geographical location information about a number of mobile stations.

The visited network 3 includes a base station controller/packet control function (BSC/PCF) 18 to which the target MS 12 is coupled, such as by radio channels defined upon a radio air interface and network connections that extend to the BSC/PCF 18. A base station controller/packet control function (BSC/PCF) generally operates, amongst other things, to control communication operations in the network. The base station controller/packet control function (BSC/PCF) 18 is, in turn, coupled to a packet data support node (PDSN) 16. The packet data support node (PDSN) 16 is, in turn, coupled to the IP (Internet protocol) network 14 of the carrier that operates the visited network, i.e., the visited network Carrier IP Network 14. And, the Carrier IP network 14, in turn, is coupled to the Internet 6. As call flow and messaging are described below with reference to IP-based LCS operations, Clients, applications, and protocols, the BSC/PCF 18 and PDSN 16 are flow-through entities. Although performing valuable functions, these network entities, the BSC/PCF 18 and PDSN 16, are not determinatively associated with the present invention and are, thus, presumed to continue performing their respective functions.

The visited network 3 of the communication system 8 also includes network-positioned entities 20, 30. One entity is referred to as a position determining entity (PDE) 20. Another entity is referred to as a serving positioning center (SPC) or serving mobile positioning center (SMPC) 30. The serving mobile positioning center (SPC or SMPC) 30 forms an entity that serves as an interface between a location service client, such as the LCS client 22, and the location service.

The home network 5 of the communication system 8 also includes an IP network 32 of the carrier that operates the home network, i.e., the home network Carrier IP Network 32. A network-positioned entity referred to as a home positioning center (HPC) or home mobile positioning center (HMPC) 28 is coupled to the home network Carrier IP Network 32. Databases, such as a subscription and billing database 36 may be coupled to the home network Carrier IP Network 32, directly or, as in FIG. 1, through the HPC 28.

A Positioning Center or Mobile Positioning Center (MPC), such as the SPC 30 or HPC 28, may serve as an interface between an LCS Client and a location service (LCS). For example, an MPC can accept requests for position determination of mobile stations from LCS Clients; perform authentication, authorization, and accounting (AAA) functions; and control the discovery and assignment of resources, such as discovering and assigning a Position Determining Entity (PDE) for an A-GPS positioning session with a mobile station. To address an inconsitency in convention, a Positioning Center or Mobile Positioning Center may also be referred to as a Position Server (PS) or similar name; regardless of the name, these entities operate in substantially the same manner to affect the same resulting function. Similarly, HPC, HMPC, HPS, etc., and SPC, SMPC, SPS, etc., refer to like entities in home or serving networks, respectively. For example, the network node described as the MPC in 3GPP2 corresponds to a like network node as the SLC (SUPL Location Center) in the terminology of the Secure User Plane Location (SUPL) protocol of the Open Mobile Alliance (OMA), and the PDE in 3GPP2 corresponds to the SPC (SUPL Position Center) in OMA terminology. Accordingly, embodiments of the present invention are not restricted to a particular access technology, such as CDMA, but can be transposed into other access technologies and related protocols.

Pursuant to operation of an embodiment of the present invention, a method is provided by which to facilitate performance of a location service (LCS) pursuant to a location-based application. When the location service (LCS) is initiated, IP-based signaling is generated, as described below, to obtain information to assist the mobile station in determination of its location and/or providing location information about the mobile station to the location-based application or service requiring the position of the mobile station. A mobile station may include a GPS receiver that performs GPS-related operations to obtain the location of the mobile station. If assisted by the network, such GPS-related operations are referred to as Assisted-GPS (A-GPS) operations.

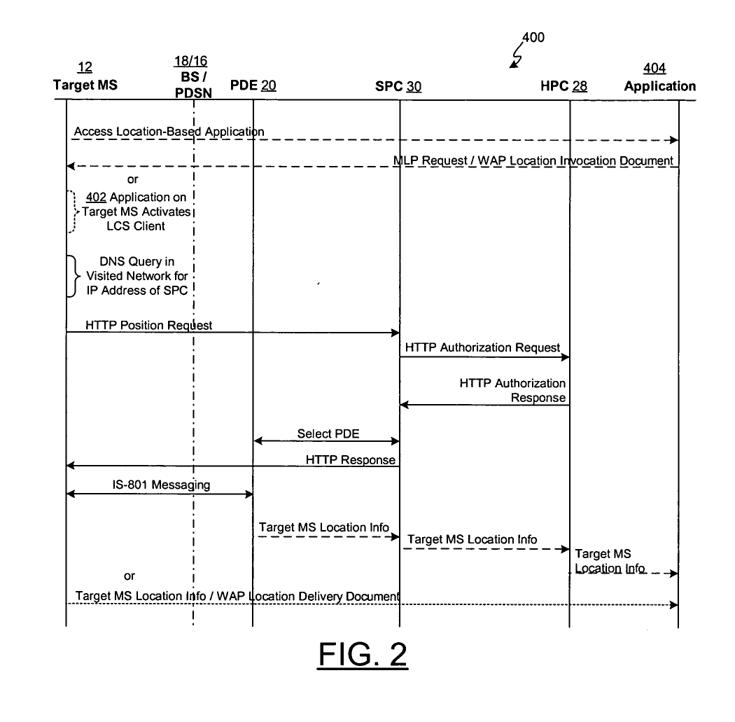

FIG. 2 is a control flow diagram illustrating IP-based location service of an embodiment of the present invention. The control flow diagram of FIG. 2 illustrates an exemplary terminal-initiated LCS beginning with a location-based application activating an LCS Client for location service (LCS) on a cellular network. The control flow diagram of FIG. 2 provides the situation where the Target MS 12 is roaming in a visited network, however the situation where a mobile station is positioned in its home network is a subset of the visited network example where a serving positioning center (SPC) is not required because the mobile station and a position determining entity (PDE) may communicatr directly with the home positioning center (HPC). The steps of acquiring IP connectivity with the communication network, such as a cdma2000 network, are not described. However, steps such as establishment of PPP connection with a PDSN, acquiring an IP address, performing authentication procedures prior to IP connectivity, and the like, which are not described, are commonly known.

A location-based application may be located, for example, on a Target MS 12 or at a remote location, such as on a network web server. In the terminal-initiated LCS control flow diagram of FIG. 2, the LCS Client is located at the Target MS 12; accordingly, the LCS Client on the Target MS 12 controls the LCS for the Target MS 12. As shown in FIG. 2, a Target MS 12 may access a location-based application 404, as may be located on a remote server, such as by issuing an HTTP GET request. For example, the user of the Target MS 12 may access the location-based application 404 on a web server by accessing a web page, clicking a link, or submitting a form. Alternatively, the Target MS 12 may access a location-based application 402 located on the Target MS 12. The location-based application 404 detects a need for location information about the Target MS 12, and in response to determining that location information is required, may return a WAP location invocation document to the Target MS 12, such as issuing an MLP Request. A WAP location invocation document typically is an XML formatted location request that indicates the need for location information and, generally, also describing attributes of location information such as position quality of service (PQoS), transaction rate or frequency of location reporting, and the like. Once the LCS Client is activated, the location service (LCS) process continues by providing the location information for the Target MS 12 to the location-based application 402, 404.

The Target MS 12 will perform a DNS query in the visited network to find out the IP address for a serving positioning center (SPC) 30. For example, the LCS Client may use a URL or formulate a fully qualified domain name (FQDN) indicative of the NID and SID information (e.g., nid.sid.mpc.net) and query the domain name server (DNS) to find out the IP address for the SPC 28. If the Target MS 12 were in its home network, the Target MS 12 would likely know, or could preform a similar DNS query to identify, the IP address for the home positioning center (HPC) 28. If an HTTP proxy is incorporated in the network, such that all HTTP requests from the Target MS 12 are trapped by the proxy, the DNS query by the Target MS 12 is unnecessary since the proxy performs DNS on behalf of the Target MS 12. Thus, the Target MS 12 simply sends the HTTP position request message to the URL, i.e., FQDN, of the SPC 30. The proxy traps the message, finds out the IP address for the SPC 30, and forwards the message to the SPC 30 for the Target MS 12.

Once the Target MS 12 identities the SPC 30, the Target MS 12 sends a position request to the SPC 30. An IP-based protocol, such as HTTP, may be used to transmit the position request. Using HyperText Transfer Protocol (HTTP) for the LCS messages provides the advantages of built in request/response semantics as well as support for authentication and encryption. Also, HTTP runs over TCP and is reliable. The position request, i.e., the HTTP position request, contains information to perform the location service (LCS), including as attributes of location information such as PQoS, transaction rate, etc., the identity of the Target MS 12, the identity of the location-based application that is to use the location information, authentication data to assert the identity of the Target MS 12 (authentication credentials), the base station identification (BSID) where the Target MS 12 is connected to the CDMA network (position attributes), and the identity of the home positioning center (HPC) 28 (HPCidentity) for the Target MS 12. The identity of the HPC 28 may be in the form of a URL or IP address or inferred from the identity of the Target MS 12 such as using the @HomeNetwork portion from the identity of the Target MS 12. The above described LCS information may be included in HTTP headers and/or HTTP payloads.

By way of example, if the LCS is implemented over HTTP, sending the position request may also include a number of sub-steps. For example, the Target MS 12 will initiate a TCP connection with the SPC 30, such as a persistent TCP connection. The Target MS 12 may send an HTTP message, such as a GET message, to the SPC 30 containing all of the location information except for authentication data. The SPC 30 may challenge the Target MS 12 for authentication and provide a nonce, such as a random number. The Target MS 12 can then run one or more cryptographic algorithms to compute a signature. The nonce and shared secret, such as a password, between the Target MS 12 and the HPC 28 may be used in addition to other information to compute the signature. Once computed, the Target MS 12 sends the signature to the SPC 30 in an HTTP message, such as another GET message including the signature.

Before continuing with the location service (LCS), the SPC 30 typically must confirm that the position request is authorized for the LCS Client. When the position request originates from the LCS Client in the Target MS 12, there is less concern that the request is authorized. However, for example, the service for the Target MS 12 may not support LCS or may charge an additional fee for LCS. Further, because a request for position information for a mobile station may originate from various sources other than the mobile station, position requests typically must be authorized. For example, the home positioning center (HPC) for a mobile station may be contacted to determine whether a position request for the mobile station is authorized. For example, the HPC can verify that the Location Distribution Control (LDC) settings for the user or subscriber account for a mobile station permit the LCS Client to obtain the position information for the mobile station. The LDC settings and information for the subscriber of the mobile station may be stored with a network node or entity in the home network for the mobile station, such as at the HPC associated with the user or subscriber of the mobile station. The HPC references an LDC database, which control and/or restrict location information distribution in the Internet, e.g., for the purpose of user privacy protection, the LDC database is a subscription database identifying whether LCS is authorized for the mobile station and/or whether performing LCS for the mobile station incurs an additional billing charge against the mobile station service account.

To perform authorization of the position request for the Target MS 12, the SPC 30 may contact the HPC 28 with an authorization request, such as using HTTP protocol, i.e., the HTTP Authorization Request. Again, as for the HTTP messaging between the Target MS 12 and SPC 30 described above, the SPC 30 and HPC 28 may establish TCP communications and use HTTP protocol messaging such as an HTTP GET or POST message. Using the identity of the home positioning center (HPC) 28 (HPCidentity) for the Target MS 12 provided by the Target MS 12 in the HTTP position request, the SPC 30 sends an authorization request to the HPC 28. The authorization request, i.e., the HTTP authorization request, contains some of the information from the Target MS 12, including the attributes of location information such as PQoS, transaction rate, etc., the identity of the Target MS 12, and authentication data to assert the identity of the Target MS 12 (authentication credentials). The SPC 30 and HPC 28 may have a security association, such as using IPSec or SSL/TLS, to protect the messaging between them.

The HPC 28 may locally run one or more cryptographic algorithms using a nonce provided by the SPC 30, a shared secret pre-established with the Target MS 12, and other information to compute a signature and to verify that the signature provided by the Target MS 12 to the SPC 30 and forwarded to the HPC 28 matches the signature computed locally by the HPC 28. If the signatures match, and the Target MS 12 is authorized for LCS, such as whether the Target MS 12 is authorized for LCS from a visited network, the HPC 28 sends a response message to the SPC 30 asserting the success of the authentication and authorization for the position request. The HPC 28 may also provide billing information to the SPC 30 to be used to record the location service usage by the Target MS 12 in the visited network. The HPC 28 interacts with an LDC database and other supporting network entities, such as a home location register (HLR), a subscription and/or billing database, or a home AAA server, to provide authentication and/or authorization.

Upon authentication and authorization from the HPC 28, the SPC 30 selects a Position Determining Entity (PDE) to assist the Target MS 12 in determining position information for the Target MS 12, such as to provide A-GPS for the Target MS 12. A carrier network, such as a visited network, or a network node, such as an SPC, can identify, from one or more available PDEs, a PDE that is suitable for a given state of the mobile station and/or state of the user and/or particular location-based application being employed by the mobile station for LCS. A PDE can be identified on factors such as, but not limited to, desired PQoS, load sharing, and/or current and approximate position of the MS, for example, based on the position of the base station with which the mobile station is currently communicating. The mobile station can provide information to facilitate the selection of an appropriate PDE to employ, such as providing the identification of the base station with which the mobile station is currently communicating.

Once identified, the SPC 30 sends information identifying the selected PDE 20 to the Target MS 12. Again, this PDE identifying information may be transmitted according to HTTP protocol, possibly using the persistent TCP connection previously established between the Target MS 12 and the SPC 30. The PDE identifying information sent from the SPC 30 to the Target MS 12 may include the IP address for the PDE 20, the particular transport protocol to use for communicating with the PDE 20 such as TCP or UDP, the associated port number for communicating with the PDE 20, a period of time or lifetime for which the PDE 20 will be assigned, and a security key that may be used to protect the communication between the Target MS 12 and the PDE 20.

Upon receipt of the PDE identifying information, the Target MS 12 may initiate and perform a messaging session with the PDE 20, such as performing an A-GPS session, to exchange messages required for determining the geographical position of the Target MS 12. Depending upon the configuration for the LCS, upon determination, the PDE 20 may transmit the position information to the location-based application or transmit the position information to the SPC 30, which, in turn, may transmit the position information to the location-base application or transmit the position information to the HPC 28, which, in turn, may transmit the position information to the location-based application. Alternatively, upon determination by the Target MS 12 and/or by PDE 20 and subsequently communicated to the Target MS 12, the Target MS 12 may transmit the position information to the location-based application that initially required the position information. The transmission of position information to the location-based application may involve sending a WAP Location Delivery document to the web server where the location-based application is resident. Alternatively, if the location-based application is local to the Target MS 12, the position information may be transferred to the application locally.

Embodiments of the present invention also provide for network-initiated location service (LCS). For example, an LCS Client on a network may desire to provide a location-based information and/or service to a mobile station. The network resident LCS Client may be activated by the mobile station, or the network resident LCS Client may be activated autonomously from the mobile station, such as where the LCS Client or an associated location-based application is programmed to provide periodic location-based information to the mobile station. For example, a user of a mobile station may activate the LCS Client when using a location-based service on a web server, such as by accessing a web page, clicking a link, or submitting a form, which, in turn, activates the LCS Client on the web server or an associated network node. Also, for example, a network resident location-based application may be programmed to provide local weather forecasts to the client once an hour, without prompting from the mobile station, but based upon the position of the mobile station. In any event, as with target-initiated LCS, an LCS Client is activated to request position information. Typically, an LCS Client would be activated by a network resident location-based application requiring position information for a mobile station.

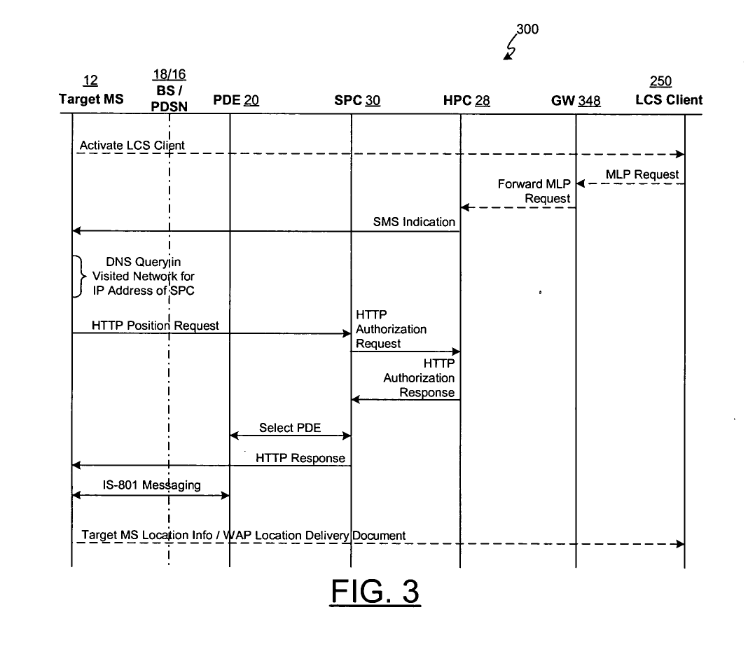

FIG. 3 is a control flow diagram illustrating IP-based location service of another embodiment of the present invention. The control flow diagram of FIG. 3 illustrates an exemplary network-initiated LCS 300 beginning with activation of a network resident LCS Client 250. The control flow diagram of FIG. 3 provides the situation where the Target MS 12 is roaming in a visited network, however the situation where a mobile station is positioned in its home network is a subset of the visited network example where a serving positioning center (SPC) is not required because the mobile station and a position determining entity (PDE) may communicate directly with the home positioning center (HPC). Again, the steps of acquiring IP connectivity with the communication network, such as a cdma2000 network, are not described. However, steps such as establishment of PPP connection with a PDSN, acquiring an IP address, performing authentication procedures prior to IP connectivity, and the like, which are not described, are commonly known.

Once the LCS Client 250 is activated to provide position information for a location-based application or service, the LCS Client 250 makes a request for the position information for the LCS. The request may be made, for example, to and through a network Gateway (GW) 348, which directs the request to the HPC 28 for the Target MS 12. In such a manner, an LCS Client may simply perform LCS operations and rely upon a gateway to perform necessary network routing functions. Mobile Location Protocol (MLP) may be used for LCS Client-to-gateway communications. MLP may be implemented over HTTP, TCP, and IP.

Once forwarded from the GW 348 to the HPC 28, the HPC 28 may send an indication to the Target MS 12 about the need/request for geographical positioning. For example, the HPC 28 may use short message service (SMS) messaging to communicate the request. The indication message to the Target MS 12 includes a reference identification (Reference ID) for the original request from the LCS Client 250 and the identity of the requesting LCS Client 250. With such information, the Target MS 12 may later provide position information directly to the LCS Client 250. The indication message, i.e., the SMS Indication, may also include information to perform the location service (LCS), including as attributes of location information such as PQoS, transaction rate, etc., the identity of the Target MS 12, and the identity of the location-based application that is to use the location information.

Upon receiving the indication message for geographical positioning, the Target MS 12 may prompt the user, such as with a pop-up message on a display, for consent to provide location information to the LCS Client 250. Alternatively, the Target MS 12 may be pre-programmed to automatically provide confirmation to provide location information to the identified LCS Client 250 and/or for the identified location-based application that is to use the location information. If confirmed with approval, the LCS operation may continue, as in the terminal-initiated LCS example described above, with a position request from the Target MS 12 to an SPC 30, authentication and/or authorization by the HPC 28 to the SPC 30, selection of a PDE 20, identification of the selected PDE 20 by the SPC 30 to the Target MS 12, and position determining messaging between the Target MS 12 and the PDE 20. Once the position information for the Target MS 12 is determined, the Target MS 12 may directly, or indirectly as described with reference to the terminal-initiated LCS example, provide the position information to the LCS Client 250. If the Target MS 12, or the user thereof, denies the LCS, the Target MS 12 sends a negative acknowledgement (NACK) directly or indirectly to the LCS Client 250, and the LCS procedure is aborted.

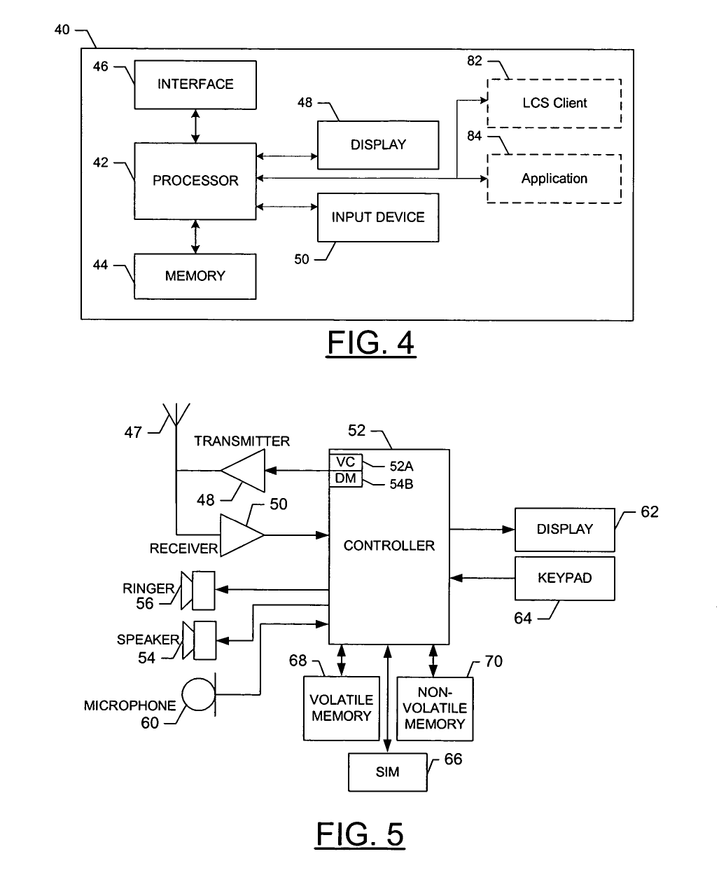

Reference is now made to FIG. 4, which illustrates a block diagram of an entity 40 capable of performing and/or facilitating location service (LCS) of an embodiment of the present invention, such as a target MS 12, PDE 20, SPC 30, or HPC 28. Although generally shown as separate network entities, in some embodiments, the entity 40 may be a network node which is a combination of network entities, logically separated but co-located within one network node, to support a mobile location service (LCS), such as a home positioning center (HPC). Similarly, a network entity may be embodied as hardware, software, or combinations of hardware and software components.

As shown, the entity 40 generally includes a processor, controller, or the like 42 connected to memory 44. The memory 44 can include volatile and/or non-volatile memory and typically stores content, data, or the like. For example, the memory 44 typically stores computer program code such as software applications or operating systems, information, data, content, or the like for the processor 42 to perform steps associated with operation of the entity in accordance with embodiments of the present invention. Also, for example, the memory 44 typically stores content transmitted from, or received by, the entity 40. Memory 44 may be, for example, random access memory (RAM), a hard drive, or other fixed data memory or storage device. The processor 42 may receive input from an input device 50 and may display information on a display 48. The processor 42 can also be connected to at least one interface 46 or other means for transmitting and/or receiving data, content, or the like. Where the entity 40 provides wireless communication, such as in a CDMA network, Bluetooth network, a wireless LAN network, or other mobile network, the processor 42 may operate with a wireless communication subsystem of the interface 46. One or more processors, memory, storage devices, and other computer elements may be used in common by a computer system and subsystems, as part of the same platform, or processors may be distributed between a computer system and subsystems, as parts of multiple platforms.

If the entity 40 is, for example, a mobile station or a network web server, the entity 40 may also include modules such as a Location Service (LCS) Client 82 and/or an Application 84 connected to the processor 42. These modules may be software and/or software-hardware components. For example, an LCS Client 82 may include software capable of initiating a location service (LCS) and receiving geographical location information for the LCS. An Application 84 may be a location-based or location-dependent application including software capable of activating an LCS Client for performing location service (LCS) to support the application.

FIG. 5 illustrates a functional diagram of a mobile device, or mobile terminal or mobile station (MS), capable of performing and/or facilitating mobile location service (LCS) of an embodiment of the present invention. The mobile device shown in FIG. 5 is a more detailed depiction of one version of an entity 40 shown in FIG. 4. It should be understood, that the mobile device illustrated and hereinafter described is merely illustrative of one type of mobile station that would benefit from the present invention and, therefore, should not be taken to limit the scope of the present invention or the type of devices which may operate in accordance with the present invention. While several embodiments of the mobile device are hereinafter described for purposes of example, other types of mobile stations, such as mobile phones, portable digital assistants (PDAs), pagers, laptop computers, and other types of voice and text communications systems, can readily be employed to function with the present invention.

The mobile device includes an antenna 47, a transmitter 48, a receiver 50, and a controller 52 that provides signals to and receives signals from the transmitter 48 and receiver 50, respectively. These signals include signaling information in accordance with the air interface standard of the applicable cellular system and also user speech and/or user generated data. In this regard, the mobile device can be capable of operating with one or more air interface standards, communication protocols, modulation types, and access types. More particularly, the mobile device can be capable of operating in accordance with any of a number of second-generation (2G), 2.5G and/or third-generation (3G) communication protocols or the like.

It is understood that the controller 52, such as a processor or the like, includes the circuitry required for implementing the video, audio, and logic functions of the mobile device. For example, the controller may be comprised of a digital signal processor device, a microprocessor device, and various analog to digital converters, digital to analog converters, and other support circuits. The control and signal processing functions of the mobile device are allocated between these devices according to their respective capabilities. The controller 52 thus also includes the functionality to convolutionally encode and interleave message and data prior to modulation and transmission. The controller 52 can additionally include an internal voice coder (VC) 52A, and may include an internal data modem (DM) 52B. Further, the controller 52 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile device may also comprise a user interface such as including a conventional earphone or speaker 54, a ringer 56, a microphone 60, a display 62, all of which are coupled to the controller 52. The user input interface, which allows the mobile device to receive data, can comprise any of a number of devices allowing the mobile device to receive data, such as a keypad 64, a touch display (not shown), a microphone 60, or other input device. In embodiments including a keypad, the keypad can include the conventional numeric (0-9) and related keys (#, *), and other keys used for operating the mobile device and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile device can also include memory, such as a subscriber identity module (SIM) 66, a removable user identity module (R-UIM) (not shown), or the like, which typically stores information elements related to a mobile subscriber. In addition to the SIM, the mobile device can include other memory. In this regard, the mobile device can include volatile memory 68, as well as other non-volatile memory 70, which can be embedded and/or may be removable. For example, the other non-volatile memory may be embedded or removable multimedia memory cards (MMCs), Memory Sticks as manufactured by Sony Corporation, EEPROM, flash memory, hard disk, or the like. The memory can store any of a number of pieces or amount of information and data used by the mobile device to implement the functions of the mobile device. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application, such as a software program or modules for an application, such as to perform and/or facilitate location service (LCS) of an embodiment of the present invention, and may store an update for computer program code for the mobile device.

One of ordinary skill in the art will recognize that the present invention may be incorporated into hardware and software systems and subsystems, combinations of hardware systems and subsystems and software systems and subsystems, and incorporated into network systems and mobile stations thereof. In each of these systems and mobile stations, as well as other systems capable of using a system or performing a method of the present invention as described above, the system and mobile station generally may include a computer system including one or more processors that are capable of operating under software control to provide the techniques described above, including performing and/or facilitating location service (LCS).

Computer program instructions for software control for embodiments of the present invention may be loaded onto a computer or other programmable apparatus to produce a machine, such that the instructions which execute on the computer or other programmable apparatus create means for implementing the functions described herein, such as a mobile station operating in accordance with location service (LCS) of an embodiment of the present invention. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions described herein. It will also be understood that each block or element, and combinations of blocks and/or elements, can be implemented by hardware-based computer systems, software computer program instructions, or combinations of hardware and software which perform the specified functions or steps of performing and/or facilitating location service (LCS) of an embodiment of the present invention.

Herein provided and described are improved systems, methods, and devices for IP-based location service (LCS) over a CDMA network. Using one or more IP-based protocols for LCS signaling efficiently re-uses existing, implemented, and reliable protocols and increases the robustness of the LCS signaling. The particular implementations of LCS messaging call flows according to embodiments of the present invention make efficient use of wireless bandwidths. Embodiments of the present invention support IP-based LCS over a CDMA network by organizing communications and signaling to limit required communications, such as by providing later-required information with initial request messages, so that IP-based protocols may be used, rather than relying upon SS7 signaling and LCS-specific communication protocols.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for location service, comprising the steps of:
activating a location service client for the location service;
requesting position information from a positioning center;
receiving the identity of a position determining entity from the positioning center; and
messaging the position determining entity to determine position information.

2. The method of claim 1, further comprising the step of initiating the location service prior to activating the location service client.

3. The method of claim 2, wherein said step of initiating the location service comprises the step of accessing a location-based application.

4. The method of claim 1, wherein said step of activating a location service client comprises the step of requesting location information for a location-based application.

5. The method of claim 1, further comprising the step of identifying the positioning center.

6. The method of claim 5, wherein said step of identifying the positioning center comprises performing a DNS query.

7. The method of claim 1, wherein said step of requesting position information comprises the step of sending a position request using HTTP protocol.

8. The method of claim 1, further comprising the steps of:
calculating position information based upon messaging the position determining entity; and
transmitting the position information after messaging the position determining entity and calculating position information.

9. The method of claim 1, further comprising the steps of:
authorizing the requested position information for the location service at the positioning center;
selecting the position determining entity; and
transmitting the identity of the position determining entity.

10. The method of claim 9, further comprising the step of receiving position information for the location service at the positioning center.

11. A method for location service, comprising the steps of:
activating a location service client for the location service;
requesting position information from a serving positioning center, wherein said step of requesting position information from the serving positioning center comprises the step of providing authentication information for permitting the serving positioning center to obtain authorization from a home positioning center to obtaining the requested position information;
receiving the identity of a position determining entity from the serving position center; and
messaging the position determining entity.

12. The method of claim 11, wherein said step of messaging the position determining entity comprises the step of providing global position system (GPS) information to the position determining entity to permit the position determining entity to calculate position information.

13. The method of claim 12, further comprising the steps of:
receiving position information from the position determining entity; and
transmitting the position information for delivery to a location-based application.

14. A method for location service, comprising the steps of:
receiving a position request from a terminal for position information for the terminal;
authorizing the position request for the terminal; and
identifying a position determining entity to interact with the terminal to determine the position information for the terminal.

15. The method of claim 14, further comprising the step of selecting the position determining entity prior to the step of identifying the position determining entity.

16. The method of claim 15, wherein said step of receiving a position request comprises the step of receiving information identifying the terminal and information identifying a base station with which the terminal is connected, and wherein said step of selecting the position determining entity comprises performing selection of the position determining entity based upon at least one of information identifying the terminal and information identifying a base station with which the terminal is connected.

17. The method of claim 14, wherein said step of authorizing the position request comprises the step of authenticating the position request for the terminal.

18. The method of claim 17, wherein said step of authenticating the position request comprises the step of transmitting authentication information for the position request to a home network entity for the terminal.

19. The method of claim 14, wherein said step of receiving a position request comprises the step of receiving information identifying a home positioning center for the terminal and information identifying the terminal.

20. A system capable of supporting location service, comprising:
a client node;
one or more server nodes including a first server node, communicably connected to said client node;
a location-based application, interactively coupled to at least one of said client node and said first server node; and
a location service client communicably connected to at least one of said location-based application, said client node, and one of said server nodes, wherein said location-based application is capable of issuing a position information request, wherein said location service client is capable of being activated in response to the position information request from said location-based application, wherein said client node is capable of issuing a positioning request to one of said server nodes.

21. The system of claim 20, further comprising a position determining entity communicably coupled to said server node receiving the positioning request and said client node, and wherein said server node receiving the positioning request is capable of selecting said position determining entity.

22. The system of claim 20, wherein said server node receiving the positioning request is capable of at least one of authorizing the positioning request and authenticating the positioning request.

23. The system of claim 20, wherein said one or more server nodes includes a second server node, and wherein said server node receiving the positioning request is said second server node.

24. The system of claim 23, wherein said one or more server nodes includes a third server node, and wherein said location service client is co-located at one of said third server node and said client node.

25. The system of claim 20, wherein said location-based application and said location service client are co-located at said client node.

26. The system of claim 20, wherein said location-based application is communicably coupled to said first server node, and wherein said location-based application is co-located at said first server node.

27. The system of claim 26, wherein said location service client is co-located at one of said first server node and said client node.

28. A client device, comprising:
a controller for supporting location service for the client device and capable of interacting with a location-based application; and
a location service client communicably coupled to said controller and capable of activation upon receipt of a position information request from said location-based application, wherein said location service client is capable of transmitting a positioning request to a serving positioning center and receiving a response to the positioning request indicating the identity of a position determining entity to interact with said location service client to determine the position information requested by said location-based application.

29. The client device of claim 28, wherein said location service client is capable of operating in accordance with one or more IP-based communications protocols for transmitting the positioning request in one of the IP-based protocols and receiving the response to the positioning request in one of the IP-based protocols.

30. The client device of claim 28, further comprising said location-based application, wherein said location-based application is communicably coupled to said controller.

31. A server, comprising:
a controller capable of supporting location service for a mobile station, wherein said controller is capable of receiving a positioning request from the mobile station, authorizing the positioning request, authenticating the positioning request, and transmitting the identity of a position determining entity to the mobile station; and
memory communicably coupled to said controller and capable of storing information identifying the mobile station, and the identity of the position determining entity.

32. The server of claim 31, wherein said controller is further capable of selecting the position determining entity for interacting with the mobile station to determine position information.

33. The server of claim 31, wherein said memory is further capable of storing information identifying at least one of a location-based application requiring position information and a location service client requesting the position information, and wherein said controller is further capable of receiving position information from one of the mobile station and the position determining entity and forwarding the position information to at least one of the location-based application and the location service client.

34. The server of claim 31, wherein said memory is further capable of storing information identifying the positioning request.
